(19) United States
(12) Patent Application Publication
(10) Pub. No.: US 2009/0022570 A1
(43) Pub. Date: Jan. 22, 2009

(54) SYSTEM, METHOD AND APPARATUS FOR FEEDING BIOMASS INTO A PRESSURIZED VESSEL

(76) Inventors: Joe David Craig, Tahoka, TX (US); Joe Don Nevill, Tahoka, TX (US); Lyle Allen Craig, Post, TX (US)

Correspondence Address: MICHAEL A. O'NEIL, P.C., 5949 SHERRY LANE, SUITE 820, DALLAS, TX, 75225, US

(21) Appl. No.: 12/173,494

(22) Filed: Jul. 15, 2008

Related U.S. Application Data
(60) Provisional application No. 60/949,911, filed on Jul. 16, 2007.
(60) Provisional application No. 60/949,920, filed on Jul. 16, 2007.
(60) Provisional application No. 60/949,968, filed on Jul. 16, 2007.
(60) Provisional application No. 60/949,957, filed on Jul. 16, 2007.
(60) Provisional application No. 60/949,977, filed on Jul. 16, 2007.
(60) Provisional application No. 60/949,982, filed on Jul. 16, 2007.
(60) Provisional application No. 60/949,990, filed on Jul. 16, 2007.
(60) Provisional application No. 60/949,917, filed on Jul. 16, 2007.

(51) Int. Cl. B65G 33/22

(52) U.S. Cl. 414/197

(57) ABSTRACT

A system, method and apparatus for feeding biomass into a pressurized vessel. The apparatus includes: a screw feeding housing with a drive motor, and a screw; and a biomass inlet, wherein the biomass is dropped in the biomass inlet and the screw feeds the biomass into the pressurized vessel.

### CROSS-REFERENCE TO RELATED APPLICATION

Applicants claim priority based on provisional patent applications Ser. Nos. 60/949,911; 60/949,920; 60/949,968; 60/949,957; 60/949,977; 60/949,982; 60/949,990; and 60/949,917; all filed Jul. 16, 2007, the entire contents of which are incorporated herein by reference.

### BRIEF DESCRIPTION OF THE DRAWINGS

FIG. 1 shows a screw feeding device of an embodiment of the invention; and

FIG. 2 shows a close-up of a portion of FIG. 1.

### DETAILED DESCRIPTION

The present invention provides an improved system, method and apparatus for feeding biomass into a pressurized vessel. It is understood, however, that the following disclosure provides many different embodiments, or examples, for implementing different features of the invention. Specific examples of components, signals, messages, protocols, and arrangements are described below to simplify the present disclosure. These are, of course, merely examples and are not intended to limit the invention from that described in the claims. Well known elements are presented without detailed description in order not to obscure the present invention in unnecessary detail. For the most part, details unnecessary to obtain a complete understanding of the present invention have been omitted inasmuch as such details are within the skills of persons of ordinary skill in the relevant art. Details regarding control circuitry described herein are omitted, as such control circuits are within the skills of persons of ordinary skill in the relevant art.

New supplies of energy have been a major concern of today's society. With the increasing costs of fuel, and volatile situation in the Middle East, alternative supplies of energy have become more important to every major society in the world. In addition, efficient use of waste products is a mandate from a waste conscious society, such as the United States. Agricultural waste products and other cellulosic waste material such as wood waste, also known as biomass, are reusable natural resources which can be utilized as a source of energy. Biomass can be converted into valuable gases through the process of gasification. This basic biomass gasification process has been in existence for many years and generally has been done at pressures ranging from just below to just above atmospheric pressure. These gases can be simply burned for heat production or used to fuel reciprocating engines. It is however very beneficial to gasify the biomass at pressures over 2 atmospheres. Gasifying biomass under pressure has many benefits. Among these benefits is that the produced gases are available to feed various processes that operate under pressure without the need for recompression. This simplifies fueling the high pressure combustion chamber of a gas turbine engine and feeding the gases to chemical processes operating under pressure.

Biomass is becoming a much more important feedstock for many chemical processes including gasification. A major impediment to the commercialization of certain biomass conversion processes is the economical injection of biomass into a pressurized vessel.

The device described within the first embodiment has been developed to economically inject biomass into vessels with pressures greater than 1 atm. Biomass is defined herein, but not limited to, cellulose fibers with varying amounts of lignin content. This biomass material is also referred to as lignocellulosic. This includes materials ranging from high density wood to pure cotton fibers. Other examples are sugarcane bagasse, straws, grasses, corn stover, rice hulls, nut shells, orchard prunings, animal manure, cotton gin trash, refuse derived fuels and other similar materials.

Plug screw feeders currently exist that form a solid plug by a process akin to extrusion. One example may be found in U.S. Pat. No. 5,996,770. This type of feeder has found success but requires large amounts of power to operate and maintenance may be problematic. The device is also highly stressed. The invention described herein is for similar types of application but greatly reduces power and maintenance requirements. It also provides for greater control over the plug formation. In addition, increased control over plug formation allows a greater range of lignocellulosic materials to be processed.

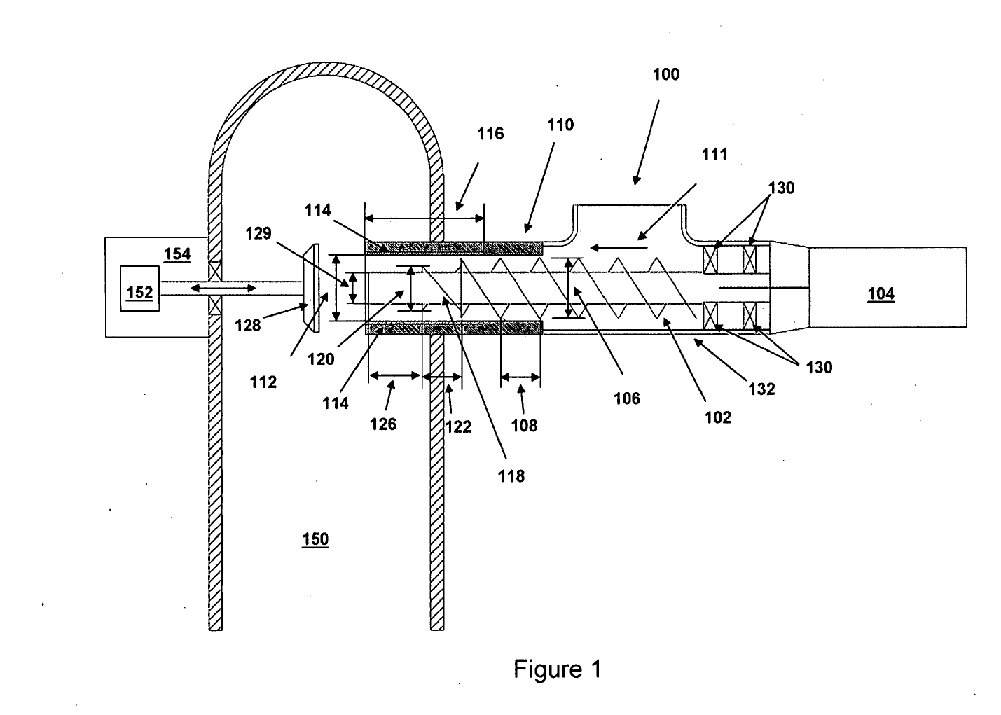

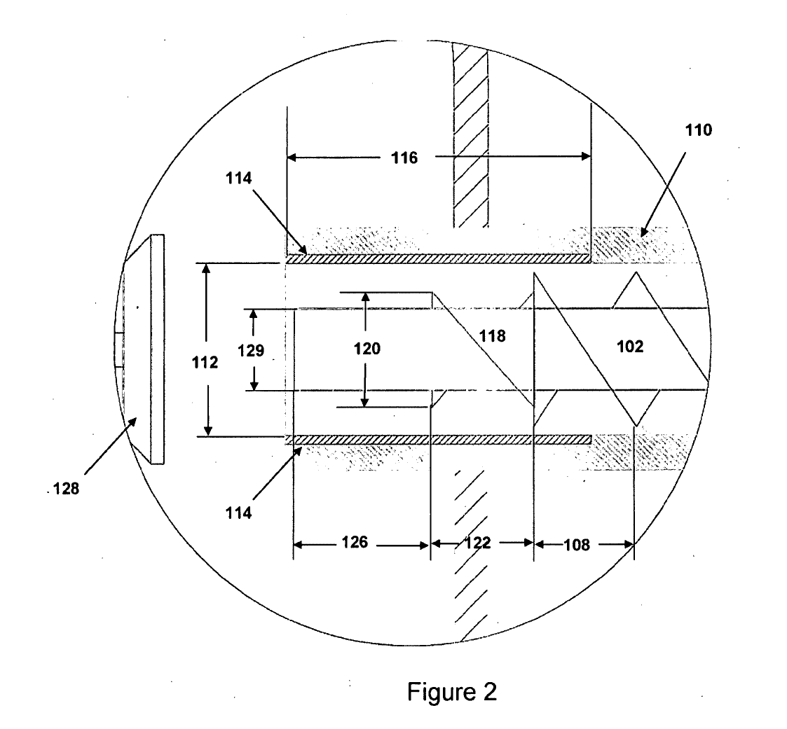

FIG. 1 shows a screw feeding device that is designed to convey biomass at atmospheric pressure into a vessel with a pressure greater than 1 atms. In addition, FIG. 2 is a close-up of a portion of FIG. 1. In FIG. 1, biomass is dropped by gravity into the screw feeder housing inlet 100. The conveyor screw 102 is rotated by a drive motor 104. In addition, thrust bearings 130 handle any thrust exerted onto the screw 102. In this embodiment, the conveyor screw 102 is double flighted with a diameter 106 and a one-half pitch 108. It conveys the biomass material horizontally into a barrel 110 as shown by arrow 111. In addition, the barrel has a constant inside diameter 112. A majority of the inside surface of the barrel 110 has a very low friction liner or coating that is also very wear resistant. The length 116 of the low friction liner 114 is shorter then the barrel and its inside diameter 112 is about the same as the barrel 110 diameter. Attached to or integral with end of the screw conveyor 102 is a smaller double flighted screw conveyor 118 with a diameter 120 and a one-half pitch 122. The end of the smaller conveyor 118 has no conveyor but is a bare shaft of a diameter 129 and a length 126.

FIG. 2 is a close-up of the barrel 110, the low friction liner 114, the screw 102 and a compression disk 128, as well as their respective diameters, lengths and pitches.

Now referring back to FIG. 1, the screw 102 pushes the biomass into the high pressure vessel 150. However, the compression disk 128 forces a back pressure onto the biomass exiting the barrel 110. This back pressure helps create a biomass plug that falls into the high pressure vessel 150. Specifically, the compression disk 128 translates horizontally as shown by the arrows while being acted upon by an actuator 152 within a housing 154. Further, the density of the resulting plug is controlled by the force that the actuator 152 imposes on the compression disk 128 that causes a force on the biomass exiting the barrel 110. The plug formed by the compressed biomass is a pressure resistant seal at the outlet end of the barrel 110.

In this embodiment, the speed of rotation of the screw controls the maximum capacity of the feeder. However, the mass flow rate of biomass entering the inlet 100 controls the actual rate of mass flow of the feeder. Moreover, the plug formed is shaped like a doughnut. In this embodiment, it is a disk with a hole in it since the barrel 100 and the end of the conveyor 118 are both round upon entry into the high pressure vessel 150. In addition, the density of this plug is controlled by the amount of force imparted by the actuator 152 to the compression disk 128. Further, the amount of torque required to rotate the screw can be controlled by the force exerted by the compression disk 128 on the biomass. The maximum amount of torque that can be applied is related to the torque rating of the motor drive 104.

In addition, the system controls the amount of force by controlling the actuator 152 and also by controlling the drive motor 104 along with controlling the rate of biomass entering the biomass inlet 100. By controlling these items, the density and size of the plugs can be controlled. However, another factor that also contributes to the density and size of the plug is the physical characteristics of the biomass including the amount of moisture. Moreover, the system also monitors any biomass backflow that goes back into the barrel 110 and adjusts accordingly. Specifically, a control loop minimizes any gases and biomass backflow.

In this embodiment, the drive motor 104 is a 10 hp gearmotor. The conveyor screw 102 is double flighted with a diameter 106 of 4½ inches and one-half pitch 108 of 3 inches, the barrel's diameter 112 is 5 inches, the length 116 of the low friction liner 114 is 9 inches, the smaller conveyor's 118 diameter 120 is 3½ inches and the one-half pitch 122 is 3 inches and the bare shaft diameter 129 is 2⅜ inches and the length 126 is 4 inches.

In addition, although in this embodiment, steel or stainless steel is used for the high pressure vessel 150 and screw 102, they may also be comprised of ceramic or similar material. Moreover, the low friction liner 114 is comprised of a replaceable thin stainless steel liner in this embodiment, it can also be comprised of steel, ceramic or a ceramic coated base material. However, it is recommended that for greater wear resistance, wear resistant materials should be used for the conveyor flights 102, 118, bare shaft end and the barrel 110.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for feeding biomass into a pressurized vessel, the apparatus comprising:
a screw feeding housing;
a drive motor;
a screw wherein the screw includes a first flight, a second flight and a bare portion and wherein the first flight diameter is larger than the second flight diameter;
a barrel within the housing, wherein the screw is within the barrel;
a low friction liner within the barrel towards the barrel outlet;
a biomass inlet, wherein the biomass is dropped in the biomass inlet and the screw feeds the biomass into the pressurized vessel;
a compression disk attached to an actuator, wherein the compression disk compresses the biomass before it drops into the pressurized vessel;
a monitor for determining if any biomass or gases backflows into the barrel;
a control loop that controls the actuator and compression disk and the drive motor and screw and adjusts accordingly to produce a biomass plug that seals against pressure.

2. The apparatus of claim 1 wherein the pressure in the vessel is greater than 1 atms.
